(19) United States
(12) Patent Application Publication
(10) Pub. No.: US 2026/0145678 A1
(43) Pub. Date: May 28, 2026

(54) VEHICLE SYSTEM OF A VEHICLE FOR BRAKE ASSISTANCE OF A BRAKING SYSTEM

(71) Applicant: AUDI AG, Ingolstadt (DE)

(72) Inventor: Christian GLÜCK, Ingolstadt (DE)

(21) Appl. No.: 19/400,842

(22) Filed: Nov. 25, 2025

(30) Foreign Application Priority Data
Nov. 27, 2024 (DE) 102024135081.4

(51) Int. Cl. B60W 30/18; B60L 1/00; B60L 1/02; B60L 7/00; B60L 15/20; B60W 10/08; B60W 10/196

(52) U.S. Cl. CPC B60W 30/18127; B60L 1/003; B60L 1/02; B60L 7/00; B60L 15/2009; B60W 10/08; B60W 10/196; B60W 2510/244; B60W 2520/06; B60W 2520/10; B60W 2552/15; B60W 2552/30; B60W 2710/08; B60W 2710/18

(57) ABSTRACT

A vehicle system of a vehicle for brake assistance of a braking system is disclosed, and may include at least two electric drives, and a recuperation unit configured to recover and process electrical energy. The vehicle system may be configured such that the recuperation unit generates electrical energy during a braking process by way of a first electric drive. The electrical energy may be used to drive a second electric drive in a traction operation opposing the braking process. The electric drives may be operated at an efficiency of at most 0.7, such that the battery is not charged and/or the battery is discharged.

### BACKGROUND

### Technical Field

The technical field of the present disclosure is devices and methods for brake assistance in vehicles.

### Description of the Related Art

Prior art describes various approaches to improving recuperation and brake assistance in vehicles with electric drives.

Known systems utilize electric drives and recuperation units to recover kinetic energy during the braking process to increase vehicle efficiency and reduce the load on mechanical brakes. This recuperation energy is typically stored in the vehicle battery, provided sufficient storage capacity is available. However, fully charged batteries carry the risk of overcharging.

DE102016004755A1 discloses a method for recuperation-based braking of a vehicle, in which electrical energy generated by a first electric machine during a braking process is dissipated by operating at least one second electric machine of the vehicle in a zero slip mode in order to prevent overcharging of a vehicle's drive battery.

CN114633629A discloses a process for energy recovery in an electric car and electronic devices.

CN115782603A discloses a method, an apparatus, an electronic device and a computer-readable medium for ensuring regenerative braking of an electric vehicle, wherein information about the road ahead and the state of charge of the electric vehicle's battery is acquired.

### BRIEF SUMMARY

The present disclosure provides a vehicle brake assistance system that enables effective use of recuperation energy without overloading the battery.

The present disclosure relates to a vehicle system for brake assistance of a braking system comprising at least two electric drives and a recuperation unit for recovering and processing electrical energy. The vehicle system may be configured such that, during a braking process, the recuperation unit generates electrical energy by way of a first electric drive of the at least two electric drives, which is used to drive a second electric drive of the at least two electric drives. In doing so, the second electric drive may be driven in a traction mode opposite to the first drive, thereby supporting a controlled braking effect.

### DETAILED DESCRIPTION

The term “electric drives” refers to motors and/or generators configured to generate deceleration force through regenerative braking and simultaneously generate or consume electrical energy. The “regenerative braking unit” comprises devices for converting mechanical energy into electrical energy, which is used to assist the braking system. The term “efficiency” describes the ratio of usable output energy to the supplied input energy in a system or machine. Efficiency indicates how efficiently energy is converted in a process and is usually expressed as a percentage or as a decimal. An efficiency of 1 (or 100%) means that all the supplied energy is converted into usable energy without any losses, whereas an efficiency of, for example, 0.7 (or 70%) means that only 70% of the input energy is converted into usable energy, with the remaining 30% being lost, often as heat. With regard to electric drives in the context of present disclosure, efficiency refers to the ratio of the mechanical energy actually generated to the electrical energy supplied. A “suboptimally low efficiency” means that the drive is deliberately operated in a less efficient range, so that more energy is converted into heat or other losses instead of usable mechanical energy. This limits the electrical energy generated to prevent battery overcharging or to enable controlled battery discharge.

In this context, the term “first electric drive” refers to a drive that operates in recuperation mode during braking and generates electrical energy. This energy may not be supplied to the battery but may be passed directly to the “second electric drive,” which may operate in a traction mode. The second drive may utilize the energy provided by the first drive to generate an opposing force that decelerates the vehicle and thus relieves the load on the braking system. The term “traction mode” describes the targeted use of the second drive to propel the vehicle in a direction of movement of the vehicle that acts opposite to a direction of a braking force.

The vehicle system may operate both electric drives at a “suboptimally low efficiency” of 0.7 or less. This efficiency is deliberately lower than the optimal efficiency of, for example, 0.9 at which the drives typically operate. The suboptimal efficiency is deliberately chosen to limit the amount of electrical energy generated and avoid battery charging. Instead, the energy may be used directly between the drives, enabling a continuous braking effect without placing a load on the battery.

The vehicle system may provide an effective braking effect through recuperation without charging the battery. This is particularly advantageous when the battery is already fully charged and therefore cannot absorb additional energy. Furthermore, the system may be configured to operate in the suboptimal efficiency range to allow controlled battery discharge if desired. Such a configuration may provide flexible energy management, enabling the mechanical braking system to be relieved of stress without the need for additional thermal sinks or battery management measures.

In some embodiments, the vehicle system may further be configured to utilize the recuperation unit exclusively in straight sections of a roadway, so that stability support is enabled in curves.

The term “straight sections of a roadway” refers to sections of road that generate little or no cornering forces, allowing the vehicle to remain stable. “Stability support in curves” means that recuperation is deactivated in curves to increase driving safety.

Such a configuration may enable the braking system to not be further affected by recuperation in critical driving situations, such as cornering, thereby improving the stability of the vehicle.

In some embodiments, the recuperation unit may be configured to direct the generated electrical energy into a secondary system so that the generated electrical energy is consumed and thus overheating of the braking system may be avoided.

The “secondary system” refers to a device or component that may absorb and consume excess energy, such as, for example, heating systems or air conditioning compressors.

The secondary system may enable effective utilization of excess energy without placing a load on the battery, reducing the risk of thermal overload of the braking system.

In some embodiments, a control unit may be provided which enables a dynamic adjustment of the efficiency of the drives based on the speed of the vehicle, a course of a driving route of the vehicle, and/or based on a state of charge of the battery.

“Dynamic efficiency adjustment” refers to the ability of the vehicle system to adjust the efficiency of the drives based on the current driving conditions, such as speed, route or battery charge level.

Dynamic efficiency adjustment may enable an adjusted energy efficiency, since the drives are operated inefficiently with a defined efficiency depending on the driving situation.

In some embodiments, a further control unit may be provided which is configured to keep the electric drives in the range of the predefined low efficiency as long as a downward gradient of a driving route of the vehicle is detected by way of a sensor.

The “downward gradient of a driving route” refers to a sloping roadway where the vehicle requires additional braking power. The “predefined low efficiency” represents a range where the drives operate inefficiently and braking power can be increased by way of the recuperation unit without charging the battery.

Such a configuration may provide improved braking performance when driving downhill without charging the battery.

In some embodiments, the vehicle system may control energy distribution between the two drives in such a way that a symmetrical braking effect is achieved without placing a one-sided load on the vehicle system.

The “symmetrical braking effect” refers to an even distribution of force on the vehicle by way of both drives in order to increase driving stability.

The symmetrical braking effect may improve driving stability, especially under high braking requirements.

In some embodiments, the vehicle system may be configured to redirect excess electrical energy generated by the recuperation unit to at least one load, such as a water heater, an air heater, an air conditioning compressor, a 12V actuator, a fan and/or a pump, so that the energy is consumed in the form of heat or mechanical work without charging the vehicle's battery.

The “loads” may comprise components such as water heaters, air heaters or air conditioning compressors that may be used to dissipate excess energy.

Such a configuration may enable thermal or mechanical utilization of the excess energy without charging the battery.

The present disclosure also provides a method for using a vehicle system for brake assistance, comprising the steps of detecting the battery charge level and activating the electric drives in the range of suboptimally low efficiency as long as the battery is fully charged in order to limit the electrical energy generated by the recuperation unit.

Such a configuration may enable the battery to not be overcharged and for braking energy to be utilized efficiently.

In some embodiments, the method may further comprise the step of activating the recuperation unit exclusively in straight sections of the roadway and deactivating the recuperation unit in curves, so that optimal stability support in curves may be enabled.

Such a configuration may improve driving stability in cornering situations by activating recuperation only in stable driving conditions.

In some embodiments, the method may comprise the step of redirecting the electrical energy generated by the recuperation unit to at least one load when required, wherein the load comprises a water heater, an air heater, an air conditioning compressor, a 12V actuator, a fan and/or a pump, so that the excess energy may be consumed in the form of heat or mechanical work without placing a load on the vehicle's battery.

Such a configuration may enable the energy generated by recuperation to be utilized efficiently without placing a load on the battery. Such a configuration may be particularly advantageous when the battery is fully charged and cannot absorb any more energy.

A vehicle system already known from the prior art can, for example, be operated at a high efficiency of 0.9. In this case, the drives operate in an optimal range to maximize energy efficiency and utilize the battery effectively. A first drive for the front axle can, for example, generate 10 kW of mechanical power in recuperation mode and supply 9 kW of DC (direct current) to the battery. A second drive for the rear axle, which can act as a traction drive, supplies, for example, 0 kW mechanical power and 0 kW DC to the battery. In this vehicle system already known from the prior art, the braking power (recuperation at the wheel) is provided by 10 kW mechanical power, while the battery is charged with 9 kW DC. The battery charge level is therefore increased by the high efficiency of the drives.

For comparison, in an exemplary embodiment, the vehicle system according to the disclosure may be used for brake assistance in a 2-axle vehicle in which recuperation power is controlled by targeted adjustment of the efficiency of the electric drives, wherein the vehicle system may be operable in different operating states in order to generate optimized deceleration force without charging the battery or using additional loads within the vehicle. In such an embodiment, the vehicle system may be operated, for example, at a low efficiency of 0.6. In such an embodiment, the recuperation of the recuperation unit may be increased by compensating for the propulsion at a low efficiency of 0.6. The first drive of a front axle may operate in such an embodiment with 15.5 kW mechanical power and 9.5 kW DC, while the second drive of a rear axle may operate with 9.5 kW mechanical power and 5.5 kW DC. The total power of the recuperation unit may therefore be 10 kW mechanical power at the wheel, and may supply a total of 0 kW DC to the battery, which therefore may not be charged. This embodiment may therefore prevent overcharging of the battery because the energy is utilized inefficiently but in a controlled manner.

In another exemplary embodiment, a low efficiency of 0.6 may also be used, with the drives being set by the control unit to maximize braking power without charging the battery. In such an embodiment, the first drive of the front axle may generate 30 kW mechanical power in recuperation mode and may supply 18 kW DC electrical energy by way of the recuperation unit. The second drive of the rear axle may be operated in traction or zero slip mode and may be powered by the generated electricity, consuming 18 kW mechanical power and subsequently supplying only 9 kW of DC, so that the battery experiences an effective discharge of −15 kW DC. The total effective braking power at the wheel may be 19 kW mechanical power, which may provide high deceleration force by way of the recuperation unit. Such an embodiment may therefore enable targeted relief of mechanical braking elements, such as brake discs, of the braking system by utilizing the excess energy to increase braking effect, without charging the battery or using additional loads.

German patent application no. 102024135081.4, filed Nov. 27, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A vehicle system of a vehicle for brake assistance of a braking system, comprising:
a first electric drive;
a second electric drive; and
a recuperation unit configured to recover and process electrical energy,
wherein the vehicle system is configured such that, during a braking process, the recuperation unit generates electrical energy by way of the first electric drive,
wherein the electrical energy is used to drive the second electric drive in a traction operation opposing the braking process,
wherein the first and second electric drives are operated at an efficiency of at most 0.7, such that the battery is not charged and/or the battery is discharged.

2. The vehicle system according to claim 1, wherein the vehicle system is further configured to utilize the recuperation unit only in straight sections of a roadway.

3. The vehicle system according to claim 1, wherein the recuperation unit is configured to direct the generated electrical energy into a secondary system, such that the generated electrical energy is consumed.

4. The vehicle system according to claim 1, further comprising a control unit configured to adjust an efficiency of each of the first electric drive and the second electric drive based on the speed of the vehicle, a course of a driving route of the vehicle, and/or a state of charge of the battery.

5. The vehicle system according to claim 4, wherein the control unit is configured to maintain the first and second electric drives in a predefined low efficiency range when a sensor of the vehicle detects the vehicle is traversing a downward gradient of a driving route.

6. The vehicle system according to claim 1, wherein the vehicle system is configured to distribute energy between the first electric drive and the second electric drive such that a symmetrical braking effect is achieved.

7. The vehicle system according to claim 1, wherein the vehicle system is configured to redirect excess electrical energy generated by the recuperation unit to at least one of a water heater, an air heater, an air conditioning compressor, a 12V actuator, a fan and a pump, such that the excess electrical energy is consumed in the form of heat or mechanical work without charging the battery.

8. A method for using a vehicle system for brake assistance according to claim 1, the method comprising:
detecting a battery charge level; and
activating the first and second electric drives at the efficiency of at most 0.7 when the battery is fully charged.

9. The method according to claim 8, wherein the method further comprises:
activating the recuperation unit only in straight sections of a roadway; and
deactivating the recuperation unit in curves of a roadway.

10. The method according to claim 8, wherein the method further comprises selectively redirecting the electrical energy generated by the recuperation unit to at least one of a water heater, an air heater, an air conditioning compressor, a 12V actuator, a fan and a pump, such that excess electrical energy is consumed in the form of heat or mechanical work without placing a load on the battery.
